(19) United States
(12) Patent Application Publication
(10) Pub. No.: US 2025/0383260 A1
(43) Pub. Date: Dec. 18, 2025

(54) INSPECTION TOOL FOR FIBER ARRAY UNIT (FAU) QUALITY MONITORING IN THE CO-PACKAGED OPTICS APPLICATION AND METHODS FOR INSPECTING USING THE SAME

(71) Applicant: Taiwan Semiconductor Manufacturing Company Limited, Hsinchu (TW)

(72) Inventors: Wen-Chih Lin, Taoyuan City (TW); Cheng-Yu Kuo, Kaohsiung City (TW); Yen-Hung Chen, Hsinchu City (TW); Hsuan-Ting Kuo, Taichung City (TW); Chia-Shen Cheng, Hsinchu (TW); Pei-Shan Ho, Hsinchu City (TW); Ching-Hua Hsieh, Hsinchu (TW); Wen-Chih Chiou, Zhunan Township (TW)

(21) Appl. No.: 18/743,329

(22) Filed: Jun. 14, 2024

(51) Int. Cl. G01M 11/00

(52) U.S. Cl. CPC G01M 11/30

(57) ABSTRACT

A method of inspecting a Fiber Array Unit (FAU) in a co-packaged optics application using an inspection apparatus, includes: Positioning the FAU in the apparatus. Utilizing a high-resolution CCD imaging system to capture detailed images of the FAU. Employing an IR CCD to assess the core pitch position of the FAU. Measuring the quality of output beams from the FAU's optical fibers using a beam profiler. Actively aligning the FAU using left and right 6-axis alignment units.

### BACKGROUND

A Fiber Array Unit (FAU) is an optical component used in optical systems and devices. The FAU may manipulate and/or direct optical signals carried by one or more optical fibers.

The FAU may include one or more optical fiber ports that may serve as an input interface and/or an output interface for optical signals. The optical fiber ports may be arranged in a linear or two-dimensional array. The FAU may also include a fiber holder (fiber receptacle) for each of the optical fiber ports. The fiber holder (fiber receptacle) may securely hold the optical fibers in place to maintain precise alignment and minimize signal loss.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is an exploded perspective view of a FAU.

FIG. 2 is a schematic perspective view of an FAU inspection system according to one or more embodiments.

FIG. 3 is a front-perspective view of a FAU inspection system according to one or more embodiments.

FIG. 4 is a table of the metrology function of the FAU inspection system according to one or more embodiments.

FIG. 5 is a diagram of the metrology function of the FAU inspection system according to one or more embodiments.

FIG. 6 is a metrology mode table with a side-perspective view of the FAU inspection system, of FIG. 3, according to one or more embodiments.

FIG. 7 is schematic view of mode-5 of the FAU inspection system, according to one or more embodiments.

FIG. 8 is a flow chart of the golden FAU selection, according to one or more embodiments.

FIG. 9 is a table of physical, optical, and light path check of the FAU inspection system, according to one or more embodiments.

FIG. 10 is a metrology table of modes 1-5 of the FAU inspection system, according to one or more embodiments.

FIG. 11 is a table of the quality of emergent light path and incident beam core pitch of the FAU of the FAU inspection system, according to one or more embodiments.

FIG. 12 is a schematic view of the IR camera according to one or more embodiments.

FIG. 13 is a schematic view of the IR camera, of FIG. 12, according to one or more embodiments.

FIG. 14 is a schematic view of the laser and beam profiler, according to one or more embodiments.

FIG. 15 is a schematic view of the laser and photodetector with an insertion loss table, according to one or more embodiments.

FIG. 16 is a schematic view of the active alignment of the golden FAU and FAU, according to one or more embodiments.

### DETAILED DESCRIPTION

The following disclosure provides many different embodiments, or examples, for implementing different features of the provided subject matter. Specific examples of components and arrangements are described below to simplify the present disclosure. These are merely examples and are not limiting. Drawings are not drawn to scale. Elements with the same reference numerals refer to the same element and are presumed to have the same material composition and the same thickness range unless expressly indicated otherwise. Embodiments are expressly contemplated in which multiple instances of any described element are repeated unless expressly stated otherwise. Embodiments are expressly contemplated in which non-essential elements are omitted even if such embodiments are not expressly disclosed but are known in the art.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device structure may be rotated as needed, and the spatially relative descriptors used herein may likewise be interpreted accordingly. Elements with the same reference numerals refer to the same element, and are presumed to have the same material composition and the same thickness range unless expressly indicated otherwise.

A Fiber Array Unit (FAU) is an optical component used in optical systems and devices. The FAU may manipulate and/or direct optical signals carried by one or more optical fibers. Generally, the emphasis on the quality of Fiber Array Units (FAUs) has not been particularly stringent in optical transceivers. This is largely due to the design and application of these optical transceivers, which typically have a larger coupling area. Photodetectors (PD) are crucial components in optical transceivers. The PDs convert light into electrical signals. Generally, in optical transceivers having larger coupling area (the area where the optical fiber interfaces with the photodetector) there is a greater tolerance and more forgiveness of minor misalignments or imperfections in the FAU. This higher tolerance means that slight variations in FAU quality do not significantly impact the overall performance of the transceiver. Because the FAU quality has not been as critical in historical configurations, there has been less emphasis on developing independent metrology tools specifically for evaluating the quality of FAUs. Metrology tools are instruments used to measure the physical and optical properties of components to ensure they meet specific standards. In contexts where FAU quality is not a key factor, the investment in developing specialized metrology tools for FAUs has not been a priority.

In contrast, in more advanced or miniaturized optical applications, such as co-packaged optics or high-density fiber connections, the quality of the FAUs becomes significantly more important. In these applications, the coupling tolerances are much tighter, meaning even small imperfections in the FAU can lead to substantial signal loss or other performance issues. As a result, there is a greater need for precise metrology tools to thoroughly evaluate and ensure the quality of FAUs in these advanced applications. This shift reflects the evolving requirements of optical technology, where miniaturization and increased performance standards necessitate more rigorous quality control measures.

The various embodiments disclosed herein present a comprehensive inspection tool that integrates a high-resolution CCD imaging system for detailed assessment of FAUs. Various embodiment systems may facilitate precise evaluation through various inspection modes, including the use of IR wavelengths for three-dimensional scanning of core pitch positions, beam profiling to assess optical fiber quality, and measuring insertion loss to evaluate signal attenuation. Such capabilities may be necessary in order to meet the rigorous quality control measures desired by advanced optical technology, ensuring that each FAU meets the stringent specifications needed for high-performance optical communication systems.

An embodiment FAU Inspection System may be designed for assessing Fiber Array Units in co-packaged optics applications and integrates a high-resolution charge-coupled device (CCD) imaging system. The embodiment FAU Inspection system may include a number of components that allow the FAU inspection system to evaluate a number of aspect to the FAU. For example, an embodiment system may include a side CCD unit, a top CCD unit, and a back CCD unit for detailed assessment of FAUs. Additionally, an infrared (IR) CCD may assess the core pitch position. Still further an embodiment system may include a beam profiler to evaluate the optical fibers' quality in the FAU. The embodiment system may also include a laser source and a beam splitter that connects the laser source to the FAU. The embodiment system may also include a power detector that measures the insertion loss of the FAU, and an active alignment system, including left and right 6-axis alignment units, aligns the FAU. Embodiment systems may include a bottom X-Y plane stage unit, configured to hold and adjust the orientation of the CCD imaging system, IR CCD, beam profiler, power detector, alignment units, and the FAU, and operates in various inspection modes.

In the first inspection mode of the system, a visible camera, part of the CCD imaging system, may be utilized to capture images of the FAU. These images may be used for automatic defect detection, linear alignment measurement, and confirming pitch or separation distances between the optical fibers of the FAU.

In the second inspection mode, the system may use the IR CCD, working in conjunction with the bottom X-Y plane stage unit. This configuration enables the system to perform a three-dimensional scan of the FAU using IR wavelengths, thereby assessing the core pitch position accurately.

An embodiment system's third inspection mode activates the beam profiler to evaluate the quality and integrity of the optical fibers within the FAU. In this mode, the profiler measures the output beams from each optical fiber to assess their quality.

In the fourth inspection mode, an embodiment FAU inspection system utilizes the power detector. The power detector component may measure the insertion loss of each optical fiber in the FAU by analyzing the attenuation of light as it passes through the fibers.

The configuration of the IR CCD and the bottom X-Y plane stage unit in second inspection mode may adjust the FAU's position and angle.

The left and right 6-axis alignment units in the FAU inspection system may produce movement in six axes: X, Y, Z, pitch, roll, and yaw.

The embodiment system may also include a power meter for measuring the optical power levels within the FAU.

In fourth inspection mode, the system uses the laser source and a photodetector to measure light attenuation. This measurement is then used to calculate the insertion loss in decibels of the FAU.

The FAU that is analyzed by the embodiment FAU inspection system may include a first surface, a second surface that opposes the first surface, and a third surface that connects the first and second surfaces. In these inspection modes, the beam splitter is connected to the first surface. A holder mounts the third surface of the FAU to the alignment units, and the second surface of the FAU faces the side CCD unit in the first inspection mode, the IR CCD in second inspection mode, the beam profiler in third inspection mode, and the power detector in fourth inspection mode.

The alignment units, the holder, and the FAU are spaced away from the bottom X-Y plane stage unit in a direction perpendicular to the longitudinal direction of the stage unit.

In the FAU inspection system, a golden FAU (i.e. test FAU) has a first surface, a second surface opposing the first surface, and a third surface connecting them. A holder may be provided, wherein the holder may include a first surface and a second surface opposing the first surface. The holder mounts the third surface of the golden FAU to alignment units because the first surface of the holder abuts the golden FAU and the second surface of the holder abuts the alignment units. The alignment units, holder, and golden FAU may be stacked on the bottom X-Y plane stage unit. The holder extends past the alignment unit in a direction perpendicular to a longitudinal direction of the bottom X-Y plane stage unit, such that the second surface of the holder directly faces the bottom X-Y plane stage unit.

The IR camera 6 may be integrated with the IR CCD 7, and the IR camera 6 may include a tilt angle of 5 degrees.

The laser source may emit laser light at 0.366 mW to the photodetector, and the power loss is between 0.10-0.12 dB. The laser source may also emit laser light at 0.366 mW to the beam profiler.

Various embodiment methods for inspecting FAUs using the embodiment integrated inspection systems are also disclosed herein. The various embodiment methods may include a first inspection mode that involves using a visible camera to capture images of the FAU. These images are then analyzed for detecting defects, measuring the linear alignment of the optical fibers, and confirming pitch or separation distances between fibers. The various embodiment methods may include a second inspection mode that includes executing a three-dimensional scan of the FAU using an IR camera, wherein the IR camera assesses core pitch position by capturing images at various angles. The various embodiments may include a third inspection mode that involves using a beam profiler to assess beam quality by measuring the shape and intensity of output beams from each fiber within the FAU. The various embodiment methods may also include a fourth inspection mode that includes measuring insertion loss by analyzing light attenuation through each optical fiber in the FAU. The various embodiment methods may also include a fifth inspection mode that includes comparing the light outputs of the FAU against a golden FAU (i.e., test FAU) and measuring misalignments or differences in output beams to evaluate the overall quality and performance.

In the first inspection mode, second inspection mode, third inspection mode, and fourth inspection mode, the FAU, a holder, and alignment units are configured to move along a longitudinal direction of the stage unit.

In the fifth inspection mode an incident beam angle of 14.1 degrees is used for entry of the laser beam into both the FAU and test FAU. In the fifth inspection mode, the measure of misalignment is between four circular channels of both the FAU and the test FAU.

The method of inspecting a Fiber Array Unit in a co-packaged optics application using this apparatus involves at least several steps. The FAU is positioned within the apparatus. The system then utilizes its high-resolution CCD imaging system to capture detailed images of the FAU. An IR CCD is used to assess the core pitch position of the FAU, and the quality of output beams from the FAU's optical fibers is measured using a beam profiler. The FAU is actively aligned using the left and right 6-axis alignment units.

Charge-Coupled Devices (CCDs) are a type of image sensor used in digital imaging technology. A CCD is an integrated circuit etched onto a silicon surface, forming light-sensitive elements called pixels. When light strikes these pixels, the light gets converted into an electrical charge, corresponding to the intensity of the light. These charges are then read out and converted into digital values to create an image. CCDs are known for their high-quality image capture, excellent light sensitivity, and low noise levels, making them particularly valuable in applications requiring precise imaging, such as in digital cameras, telescopes, and various scientific instruments. Their ability to accurately capture fine details and subtle variations in light intensity has made them a cornerstone in the field of digital imaging. The metrology tool described below provides a systematic way for inspecting FAU quality with the help of CCDs, other tools, and the like.

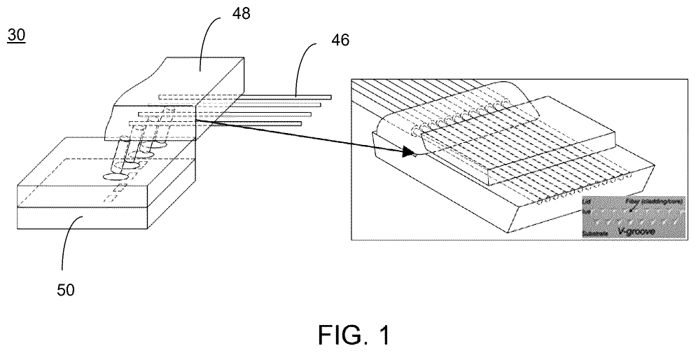

FIG. 1 is an exploded perspective view of a FAU 30 according to one or more embodiments. FIG. 1 illustrates the Fiber Array Unit (FAU) 30 in co-packaged optics applications. The FAU 30 may include the FAU substrate 50, which provides a stable base for the optical fibers and may be composed of a transparent, rigid material like glass or acrylic. In some embodiments, the FAU substrate 50 may be glass. The FAU 30 may include optical fibers 46 and electrical wiring connection. The optical fibers 46 and electrical wiring may provide data connections and electrical signals by transmitting optical data signals as well as electrical and data signals over the electrical wiring connections. The optical fibers 46 may consist fiber optics. The electrical wiring may include coper wiring, although other suitable metal wiring materials may be within the contemplated scope of disclosure. The FAU lid 48 may serve as a protective cover that could be made of a durable polymer or metal for environmental shielding. The FAU 30 may include a microcontroller or microprocessor that controls an operation of the FAU 30.

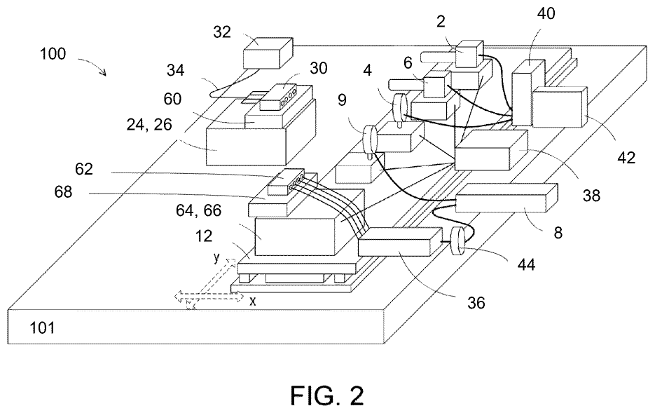

FIG. 2 illustrates a FAU inspection system 100. The FAU inspection system 100 may be placed on a substrate structure 101. In operation, a FAU 30 may be placed on the FAU inspection system 100 for analysis and inspection. The FAU 30 may include a precisely arranged array of optical fibers, encased and interfaced with suitable connectors for reliable signal transmission. This substrate structure 101 may have a flat surface that supports the other component of the FAU inspection system 100 and provides a surface to which the other components may be mounted to, such as a table-like structure (but not limited to such structure). The FAU inspection system 100 may include a laser source 32, which may generate a precise laser beam that may be directed towards a beam splitter 34. The laser source 32 (which may include laser diodes or fiber lasers) produces a coherent laser beam for various inspection tasks. The beam splitter 34 divides the emitted laser beam (from the laser source 32) and splits it into multiple paths. Each of the multiple paths may then be used for different FAU 30 inspection processes for subsequent processing and analysis. The beam splitter 34 may be made from specialized optical glass or crystals, ensuring minimal loss and high accuracy in beam division. The beam splitter 34 may be mounted directly to the FAU 30 such that the beam splitter 34 is able to move with the FAU 30. An active alignment system's left and right 6-axis alignment units 24, 26 may be mounted to the FAU 30 via a holder 60. The holder 60 may be any suitable structure known in the art for holding the FAU 30. The holder 60 may move along a surface of the units 24, 26. These units 24, 26 may be placed in such a manner as to facilitate the precise alignment of the FAU 30. The units 24, 26 may ensure that the FAU 30 is aligned accurately in multiple axes for detailed inspection. The units 24, 26 six-axis control allows for adjustments not only in linear directions but also in rotational axes, providing a comprehensive alignment solution. In an exemplary embodiment, the alignment units 24, 26 are capable of precise movement in the X, Y, Z, pitch, roll, and yaw axes. The units 24, 26 may be constructed using materials such as aerospace-grade alloys for robustness and precision, equipped with fine-tuning mechanisms for meticulous alignment.

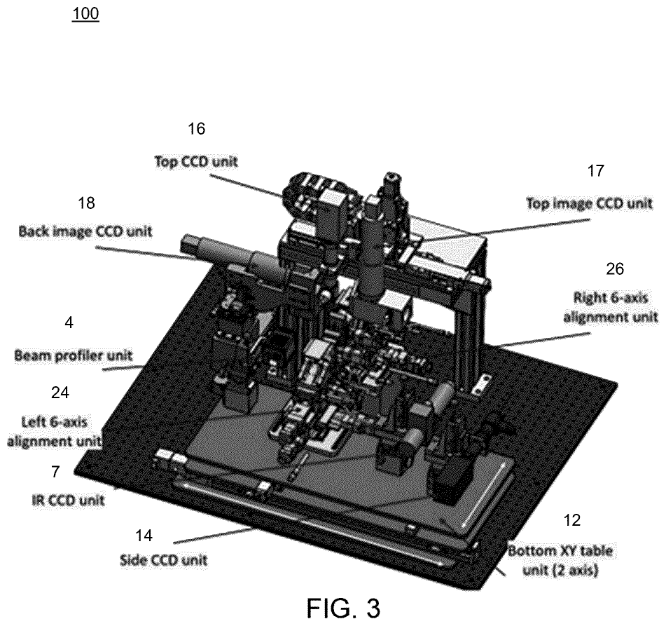

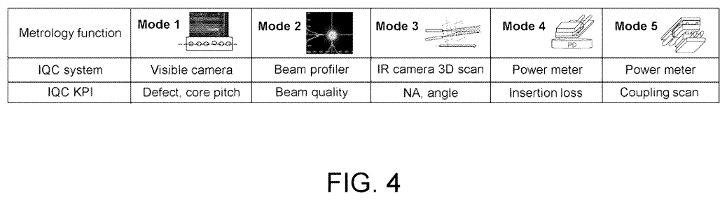

A visible camera 2 (integrated with a side CCD unit 14 as shown in FIGS. 3-4) may be positioned adjacent to the FAU 30. The visible camera 2 (unit 14) may capture high-resolution images to evaluate the FAU's 30 core pitch using incident visible light. This unit 14 may be made up of advanced silicon-based sensors and integrates a specialized lens module of the visible camera 2. The lens may be made of optical-grade glass which focuses the incident light onto a CCD sensor of the unit 14. The CCD sensor of unit 14 converts the incident light into electrical signals for analysis.

An IR camera 6 (integrated with an IR CCD unit 7) may assess a core pitch position of the FAU 30 by using IR wavelengths to accurately measure the position and orientation of each fiber within the FAU 30. A beam profiler 4 may measure and analyze the shape, intensity, and uniformity of output beams from each fiber 46 of the FAU 30, providing valuable data for quality assessment.

A power detector 9, photodetector (PD) 44, and power meter 8 may be positioned to measure and monitor optical power levels and light characteristics of the FAU 30. In an exemplary embodiment, the detectors 9, 44 may consist of semiconductor materials like silicon or germanium, for analyzing the optical properties of the light passing through or emitted from the FAU 30.

A personal computer (PC) 40 may be used for data processing and system control and serve as the central processing and control unit of the FAU inspection system 100. The PC 40 may be directly connected to the visible camera 2, IR camera 6, and the beam profiler 4. The PC 40 interfaces with a display unit 42 for visual output, collectively forming the system's user interface and data analysis hub. The display unit 42 (i.e. an LCD or OLED monitor) may provide a visual interface for the operator, displaying real-time data, system status, and inspection results.

Referring to FIGS. 2 and 3, a bottom X-Y plane stage unit 12 may be positioned centrally in the FAU inspection system 100. In an exemplary embodiment, the bottom X-Y plane stage unit 12 may be a flat, rectangular platform table. The visible camera 2, the IR camera 6, the beam profiler 4, and the power detector 9 may be placed on top of the bottom X-Y plane stage unit 12. The alignment units 24, 26 may be spaced away from and move along the bottom X-Y plane stage unit 12. In addition, the alignment units 24, 26 may be mounted on top of the bottom X-Y plane stage unit 12. The PC 40, stage controller 38, and the switch 36 may abut and extend past the bottom X-Y plane stage unit 12. The bottom X-Y plane stage unit 12 may be constructed from aluminum or stainless steel (or other materials used in the art) to ensure stability and precision. A stage controller 38 may be electrically coupled to the bottom X-Y plane stage unit 12 such that there is precise movement and positioning of the bottom X-Y plane stage unit 12 and controller 38.

Referring back to FIG. 2, a golden FAU 62 may be a test or verified FAU unit that is considered a standard or benchmark for quality and performance. The golden FAU 62 may be used as a reference point or a standard against the FAU 30 that is under inspection to be measured and evaluated. The golden FAU 62 is known for its optimal characteristics, including precise alignment of optical fibers, minimal insertion loss, and excellent overall build quality. The golden FAU 62 embodies the ideal properties and performance metrics that the FAU 30 that is under inspection, aspires to achieve. The comparison between the golden FAU 62 and the FAU 30 that is under inspection helps in identifying deviations or defects in the FAU 30 and ensures that the FAU 30 meets the stringent quality standards set by the golden FAU 62. The FAU inspection system 100 may compare the light output of the golden FAU 62 to that of the FAU 30 under inspection. The golden FAU 62 may be connected to the golden holder 68. The golden holder 68 is connected to the left and right 6-axis alignment units 64, 66. The left and right 6-axis alignment units 64, 66 are connected and move about the bottom X-Y plane stage unit 12. As the name implies, the left and right 6-axis alignment units 64, 66 may provide six axes of movement: X, Y, Z, pitch, roll, and yaw. The golden holder 68 is connected to a switch 36. The FAU inspection system 100 uses the switch 36 for selectively directing incident and laser light to the golden FAU 62 and/or the FAU 30. In an exemplary embodiment, the switch 36 may be electrical or optical. The switch 36 may control the flow of signals or power within the FAU inspection system 100. The material composition of the switch 36 may be conductive elements such as copper or gold for electrical switches, or optically transparent materials like silica for optical switches, known for their reliability in signal transmission and low signal loss characteristics.

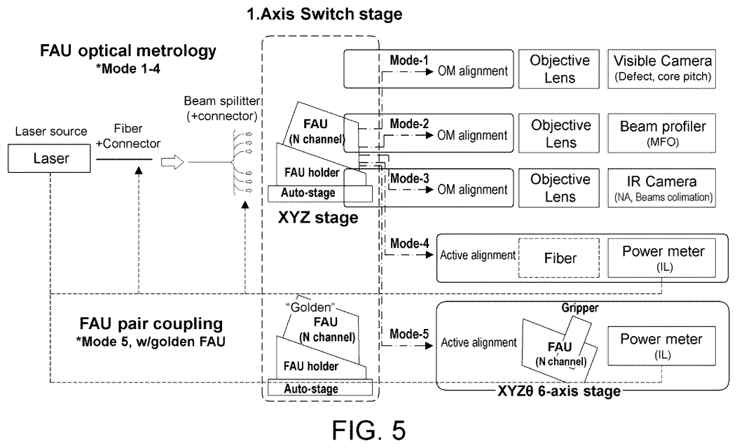

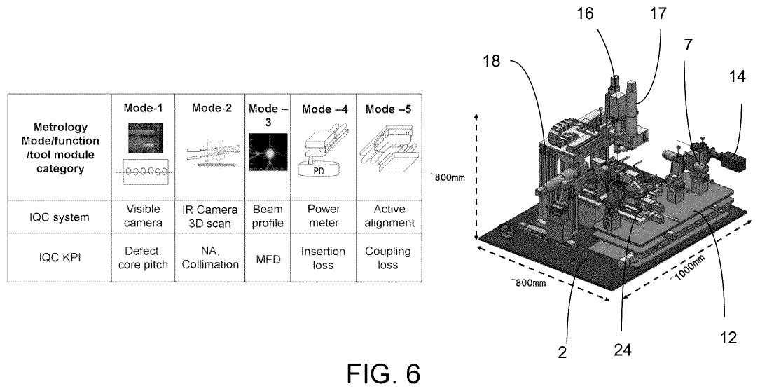

Referring to FIGS. 3-6, a side CCD unit 14, top CCD unit 16, and back CCD unit 18 may be used for the FAU inspection system's 100 imaging processes. The side CCD unit 14, top CCD unit 16, and back CCD unit 18 may be strategically placed to capture comprehensive images of the FAU 30 under inspection from different perspectives. Each of the side CCD unit 14, top CCD unit 16, and back CCD unit 18 may consist of high-resolution CCD sensors, which are highly sensitive to light and capable of capturing detailed images. The top CCD unit 16 and back CCD unit 18, along with the side CCD unit 14, may form a triad of imaging capabilities around the FAU 30. Each of the side CCD unit 14, top CCD unit 16, and back CCD unit 18 may be strategically located to capture images of the FAU 30 under inspection from multiple angles, allowing for a full 360-degree analysis of the FAU 30. The top CCD unit 16 and the back CCD unit 18, may be equipped with high-resolution CCD sensors for capturing images that are not easily accessible by the side CCD unit 14. The positioning of each of these side CCD unit 14, top CCD unit 16, and back CCD unit 18, relative to the FAU 30 and in conjunction with the bottom X-Y plane stage unit 12, allows for versatile imaging capabilities and facilitates adjustments for angle and pitch assessments of the FAU 30. Each of the side CCD unit 14, top CCD unit 16, and back CCD unit 18 may be composed of durable materials such as aluminum or polycarbonate for the body, ensuring resilience in an industrial setting.

By capturing images from various perspectives, angles, and utilizing different wavelengths of light, the FAU inspection system 100 may generate a comprehensive profile of the FAU's 30 optical and physical characteristics. This multi-faceted approach is vital for detecting any irregularities or deviations in the FAU 30, ensuring that each FAU 30 meets the stringent specifications required for high-performance optical communication systems.

Referring to FIGS. 4-6, the FAU inspection system 100 analyzes the FAU in 30 in multi-step modes. In the exemplary embodiment, the FAU inspection system 100 analyzes the FAU via five modes. However, more or fewer modes may be implemented in the inspection method. In addition, the order to the different modes of inspection may vary. While the instant application describes the five modes of inspection in a particular order, one of skill in the art would understand that the various modes of inspection may be initiated and performed in any of a variety of orders.

In a first inspection mode (mode-1), the visible camera 2, for imaging the FAU 30, detects defects, confirms linear alignment of optical fibers 46. The visible camera 2 may also verify pitch or separation distances. The FAU inspection system 100 2 may be a high-resolution digital camera to capture detailed images of the FAU's 30 exterior.

In a second inspection mode (mode-2), the IR Camera 6 may capture images of the optical fibers 46 of the FAU 30 from various angles for measuring numerical aperture by introducing IR light into each fiber core. The bottom X-Y plane stage unit 12 plays a key role in this mode, moving the FAU 30 to facilitate a three-dimensional scan.

In a third inspection mode (mode-3), the FAU inspection system 100 may use laser light (from laser source 32) and the beam profiler 4 (equipped with specialized sensors, possibly silicon-based photodiodes) to assess the shape and quality of the output beams from the FAU's fibers 46. The data from the beam profiler 4 provides information regarding on the beam's characteristics, contributing to a thorough quality assessment.

In a fourth inspection mode (mode-4), the FAU inspection system 100 may use a laser source 32 to transmit a known power level of light through the optical fibers 46 of the FAU 30. The FAU inspection system 100 may then measures the intensity of light that emerges from an end of each optical fiber 46. This measurement of light intensity may be done using a photodetector 44 or power meter 8, which captures the transmitted light and converts it into an electrical signal. The intensity of this signal may then be used to calculate the power of the transmitted light. The insertion loss may be determined by comparing the initial power level of the light source of the laser light (before entering the FAU 30) with the power level after the laser light has passed through the optical fibers 46 of the FAU 30. This comparison is usually expressed in decibels (dB).

In a fifth inspection mode (mode-5), the FAU inspection system 100 may compare the light outputs of the FAU 30 against a test or verified golden FAU 62. The fifth inspection mode may utilize the comparison of images obtained by the beam profiler 4 from previous fourth inspection mode (i.e., mode-4) with the golden FAU 62. This fifth inspection mode may be used for detecting and measuring misalignments or differences in output beams, highlighting the system's capacity to ensure consistent and high-quality FAU 30 production. The switch 36 is responsible for selectively directing light to the FAU 30 or the golden FAU 62. This could involve alternating the light path between the FAU 30 and the golden FAU 62 or simultaneously channeling light to both for comparative analysis.

As described with reference to FIGS. 2-6, the FAU 30, holder 60, and alignment units 24, 26 move along a “y” direction of the bottom X-Y plane stage unit 12 in first inspection mode, second inspection mode, third inspection mode and further inspection mode (i.e., modes 1-4). In an exemplary embodiment of modes 1-4, the first surface of the FAU 30 may directly face each of the visible camera 2, IR camera 6, beam profiler 4, and power detector 9 (respectively). Whereas the second surface (that opposes the first surface) of the FAU 30 may be connected to the beam splitter 34 in modes 1-4. In modes 1-4, the FAU 30, holder 60, and alignment units 24, 26 may be spaced away from the bottom X-Y plane stage unit 12. In the fifth inspection mode, the FAU 30, holder 60, and alignment units 24, 26 move along both the “y” and an direction of the bottom X-Y plane stage unit 12. Movement in the “x” direction allows the alignment units 24, 26 to be placed on the bottom X-Y plane stage unit 12, and the alignment units 24, 26 are spaced away from each of the edges of the bottom X-Y plane stage unit 12. In an exemplary embodiment of the fifth inspection mode, the holder 60 abuts the alignment units 24, 26 and extends past the units 24, 26 such that a surface of the holder 60 directly faces the bottom X-Y plane stage unit 12. The switch 36 may be directly connected to the FAU 30, via wires, at the first surface that opposes the second surface in which the beam splitter 34 connects to the FAU 30. In mode 5, the beam splitter 34 is no longer connected to the FAU 30.

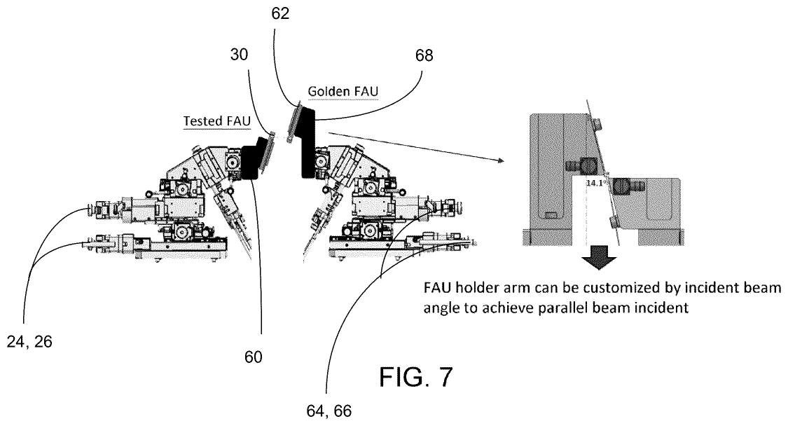

FIG. 7 is a schematic depiction of the FAU 30 and a golden FAU 62 are presented for inspection and evaluation. The golden FAU 62 may serve as a benchmark for optimal performance and quality, against which the golden FAU 30 may be compared. Both the FAU 30 and the golden FAU 62 may be mounted on holders 60, 78 that are designed to precisely adjust their position, enabling an accurate comparison of their respective optical outputs. The setup ensures that the incident light beams, introduced by a laser source 32 (depicted in FIG. 2), are parallel as they enter both the FAU 30 and the golden FAU 62. An accurate alignment is desired so that a fair and consistent comparison may be obtained. The FAU holders 60, 78 are shown connected to alignment units 24, 26 and 64, 66, which are all capable of fine-tuned angular adjustments, ensuring that the orientation of each of the FAU 30 and the golden FAU 62 may be meticulously and precisely controlled to achieve the desired parallel incident angle for the inspection process. In an exemplary embodiment, the setup for evaluating the FAU 30 and the golden FAU 62 necessitates a specific incident beam angle, which is set at 14.1 degrees to optimize the entry of the laser beam into both the FAU 30 and the golden FAU 62. In this manner, the light may be ensured to be coupled efficiently into the optical fibers 46 of the FAU 30. The 14.1-degree angle aligns with the acceptance angle of the optical fibers 46, which is a measure of the range of angles over which the optical system may accept or emit light.

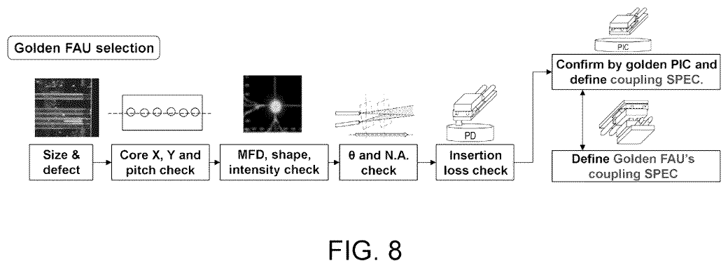

FIG. 8 illustrates the process flow of an embodiment inspection process for the golden FAU 62, which is utilized as the standard reference in the FAU inspection system 100. The inspection process involves several key assessments: in a first inspection mode, the size and shape of the FAU 30 may be inspect to determine whether the FAU 30 meets various size and shape characteristics or whether a defect is present. These determinations may be made with the side CCD unit 14, top CCD unit 16, and back CCD unit 18; in a second inspection mode, a core X, Y, and pitch check may be made with the IR Camera 6 to ensure alignment precision; in a third inspection mode the a beam profiler 4 may check an MFD (Mode Field Diameter) and NA (Numerical Aperture) to evaluate optical characteristics; in a fourth inspection mode a laser light source may be used to check for insertion loss to assess the transmission efficiency; and in a fifth inspection mode the FAU 30 may be compared against the golden FAU 62 to compare light outputs.

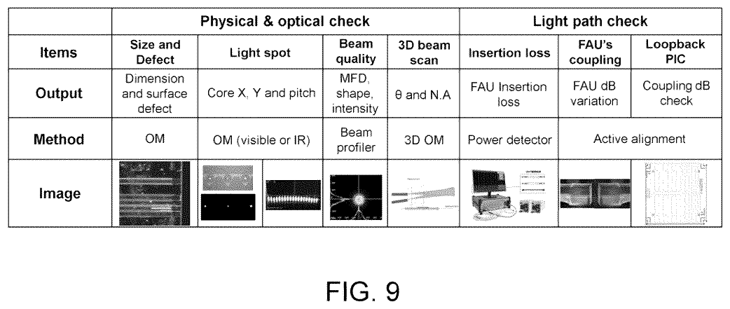

FIG. 9 illustrates a systematic sequence of physical and optical examinations that may be performed in an embodiment method. The systematic sequence of physical and optical examinations may be highly desired to validate the performance of FAU 60 within a light path configuration. The inspection begins with a detailed optical check, where parameters such as beam shape, Mode Field Diameter (MFD), and Numerical Aperture (NA) are meticulously evaluated. Mode field diameter (MFD) is an important parameter in the field of fiber optics, particularly when describing the distribution of the optical power across the core of a single-mode optical fiber. MFD is defined as the diameter at which the intensity of the light in the fiber's core drops to a specific fraction (usually 1/e², where e is the base of natural logarithms) of maximum intensity at the center of the core.

MFD is considered because it provides insights into how light interacts with the fiber, affecting the coupling efficiency between fibers and the light source, fiber-to-fiber connections, and the general performance of the fiber optic system. The MFD is also important in determining splice losses when fibers are joined and in the design and optimization of fiber optic components such as connectors, splices, and couplers. The effective area of the fiber, which is related to the MFD, impacts the fiber's susceptibility to nonlinear effects, such as self-phase modulation and stimulated Brillouin scattering. These nonlinear effects are more pronounced in fibers with smaller mode field diameters. Thus, understanding and accurately measuring the MFD is essential for ensuring optimal performance and reliability in fiber optic systems.

Numerical Aperture (NA) is an optical parameter that describes the light-gathering ability and angular acceptance of an optical fiber or any optical system. NA quantifies the maximum angle to which the optical system may accept or emit light. In the context of optical fibers, NA is particularly important as it determines how efficiently light can be coupled into and guided by the fiber. A higher NA allows more light to be captured from a light source but also tends to increase the dispersion, as more rays at different angles propagate through the fiber. This can affect the performance of the fiber in high-speed or long-distance communication applications by broadening the pulse of light sent through the fiber, potentially leading to overlap of signals and errors in data transmission.

The various embodiment methods disclosed herein include the utilization of sophisticated beam profiling techniques and 3D measurement tools to capture precise images and data points, which are illustrated in the corresponding images section of the figure. Moving to the light path assessment, system 100 implements a loopback test using a Photonic Integrated Circuit (PIC) designed specifically for loopback functionality. This process involves directing the light through the FAU 30 and back into the system 100 to ensure proper routing and connectivity. Coupled with this is the optical module (OM), which facilitates the conversion between electrical and optical signals, allowing for comprehensive testing of the entire signal transmission pathway.

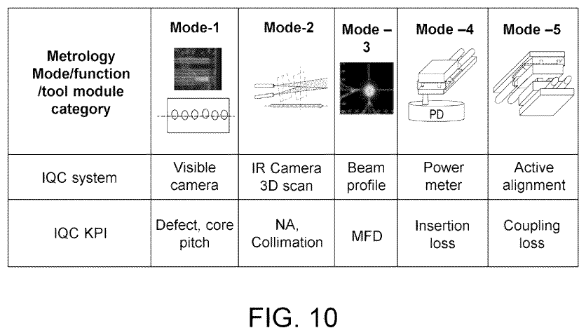

FIG. 10 illustrates modes 1-5 corresponding to specific inspection criteria within the Internal Quality Control (IQC) system, and contributing to the overall Key Performance Indicators (KPIs) for quality assessment. In mode-1, the system 100 utilizes the visible camera 2 to capture images of the FAU 30, a step pivotal in the metrology category of the IQC system, impacting the IQC KPI by determining the end-face quality and the alignment accuracy of the FAU 30. This mode is essential for identifying physical defects and ensuring the FAU 30 meets dimensional specifications for high-speed applications such as 400G/800G.

Mode-2 utilizes the IR camera 6 for 3D scans, directly affecting the IQC's NA and core pitch collimation KPIs. This mode's accurate assessment of core pitch and numerical aperture ensures that the FAU's 30 optical fibers are precisely aligned and capable of maintaining the integrity of the light signal, critical for efficient light transmission in optical communication systems.

In mode-3, the system 100 activates the beam profiler 4 to measure the Mode Field Diameter (MFD), directly correlating with the IQC's active alignment KPI. By assessing the MFD, this mode ensures the optical fibers 46 in the FAU 30 are properly dimensioned and shaped for uniform light distribution, crucial for optimal performance.

Mode-4 focuses on quantifying insertion loss using the power meter 8, directly informing the IQC KPI related to coupling loss. The ability to measure insertion loss is critical for evaluating the FAU's 30 efficiency in signal transmission, a vital metric in ensuring high-quality optical connections.

Finally, mode-5 advances the system's 100 capability to perform active alignment checks. The FAU 30 is positioned and aligned with high precision, influencing the IQC KPI for alignment verification. The accuracy of this alignment helps minimize signal loss and maintain signal integrity across optical connections.

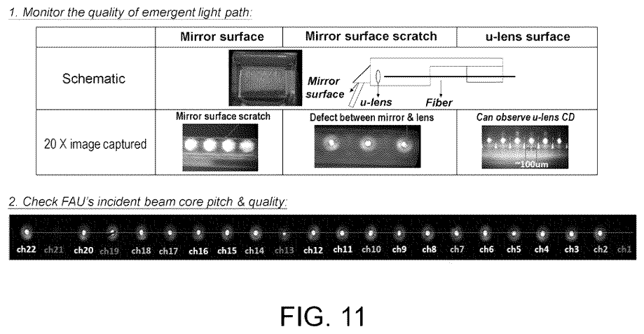

FIG. 11 illustrates the inspection process focusing on various critical surfaces and components of the FAU 30. FIG. 11 shows a schematic representation alongside actual magnified images, emphasizing the inspection of the mirror surface, surface scratches, and the u-lens surface. The mirror surface affects the reflectivity and performance of the optical path within the FAU 30. Any imperfections or degradation, including surface scratches, can significantly impact the optical signal integrity, and thus, are meticulously inspected for quality assurance. Additionally, FIG. 11 showcases the u-lens surface inspection, which is for ensuring that the lensing element within the FAU 30 is free of defects and aberrations that could distort the optical beam. Precise beam core pitch measurement is also depicted, highlighting the system's 100 capability to assess the alignment of the beam cores, which is essential for optimal light coupling efficiency.

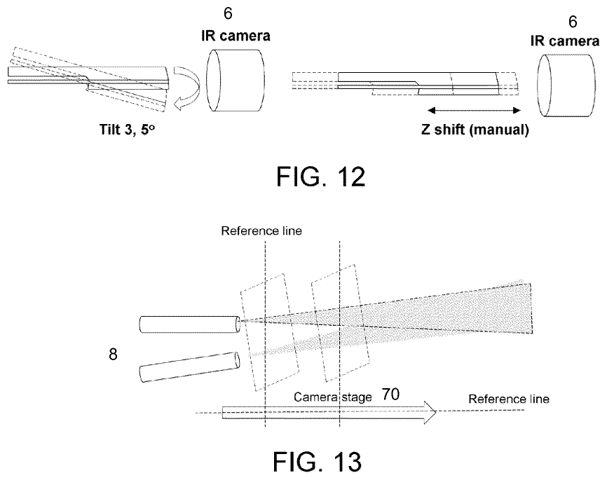

FIG. 12 focuses on the IR camera 6 in the inspection process. The IR camera 6 is positioned to capture detailed images of the FAU 30, particularly for 3D scans that assess core pitch and other critical dimensions. The IR camera's 6 ability to detect IR light is valuable for analyzing components that are not visible to the naked eye. FIG. 12 also depicts a manual Z shift mechanism, which enables fine vertical adjustment of the IR camera's 6 position, optimizing focus and clarity of the image. Additionally, a tilt mechanism is shown, indicating that the IR camera 6 may be adjusted to align with the FAU 30 for accurate image capture. In an exemplary embodiment, the FAU inspection system 100 may allow for separate tilt settings: one being “Tilt 3” and the other being “5 degrees.” “Tilt 3” may be a preset or a specific positional setting within the system's configuration, while “5 degrees” refers to the actual angular measurement by which the IR camera 6 can be tilted.

FIG. 13 illustrates the camera stage (which may apply to any of the cameras of the FAU inspection system 100) which is responsible for precise lateral and angular positioning of the visible camera 2 and/or the IR camera 6 relative to the FAU 30. A reference line is established as a basis for these adjustments, ensuring that the camera maintains a specific orientation and distance from the FAU 30 during inspection. The camera stage's adjustability is crucial for maintaining consistency and accuracy across successive inspections and for calibrating the system according to the established reference line.

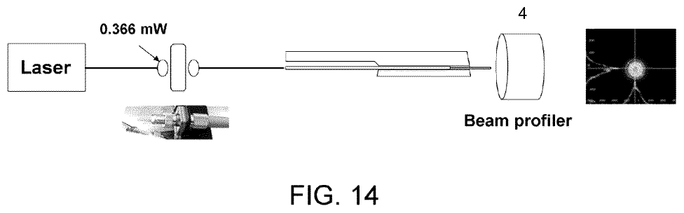

FIG. 14 illustrates the beam profiling setup. At the base of the setup is a laser that emits a beam with a power of 0.366 milliwatts (mW) (but not limited to this power output for setup), which is directed upwards towards the beam profiler 4. The specific power rating of the laser is significant as it ensures that the beam is strong enough to provide clear data without risking damage to the components being tested. The beam profiler 4 may be strategically placed in the path of the laser beam to analyze its characteristics, such as its shape, size, and power distribution.

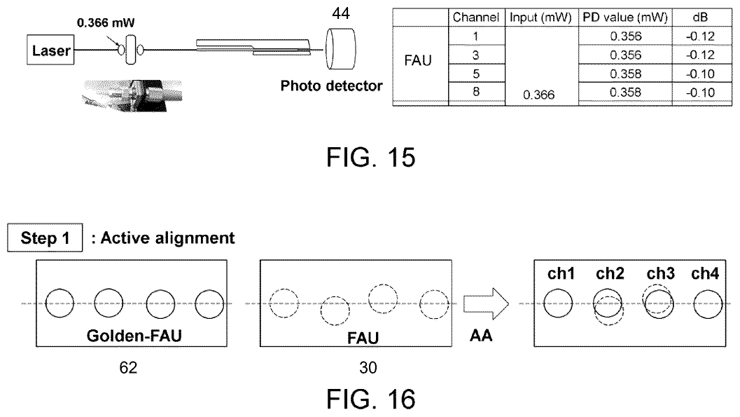

FIG. 15 illustrates the utilization of a laser, calibrated to emit at 0.366 milliwatts (mW), and a photodetector 44 to measure the power across multiple channels of the FAU 30. The laser introduces a controlled light input to the FAU 30, and the photodetector 44 captures the output light, which is quantified in mW. The values shown, from channel inputs to PD values, provide real-time data on the power loss within each channel of the FAU 30, subsequently converted into decibel (dB) values. These dB values are indicative of the FAU's 30 efficiency, reflecting the insertion loss that occurs as light travels through the FAU 30.

FIG. 16 depicts active alignment (AA) as a step for ensuring the optimal positioning of the FAU 30 relative to the golden FAU 62. FIG. 16 demonstrates the system's alignment process across multiple channels (ch1 to ch4), ensuring that each fiber within the FAUs 30, golden FAU 62 are accurately aligned. The active alignment step is vital in preparing the FAUs 30, golden FAU 62 for testing, as it directly impacts the accuracy of subsequent power measurements and overall performance evaluations. Precise alignment is imperative for maintaining consistent optical signal transmission and for benchmarking the golden FAU 30 against the high-quality standard set by the golden FAU 62.

In some embodiments, the FAU inspection system 100 may include additional features to augment the capabilities and applicability. For example, the FAU inspection system may include automated defect recognition software. By implementing advanced image processing algorithms and machine learning techniques, various embodiment FAU inspection systems 100 may be able to automatically detect and classify defects in the FAU 30 structure. In other embodiments, the FAU inspection system 100 may include an integrated environmental control. For example, temperature, humidity, and vibrations may impact the FAU 30 during inspection. By incorporating a system for controlling environmental factors, the embodiment FAU inspection system 100 may be able to mitigate factors that may negatively impact the FAU 30 during inspection. In other embodiments, the FAU inspection system 100 may include a data analytics platform. By incorporating a comprehensive data analytics platform to analyze inspection data over time, the FAU inspection system 100 may provide insights into trends, potential failure modes, and allow for production process optimization. In other embodiments, the FAU inspection system 100 may include enhanced optical resolution. For example, by improving the resolution of the imaging systems, the FAU inspection system 100 may potentially through the use of higher resolution sensors or advanced optics, detect micro-scale defects. In other embodiments, the FAU inspection system 100 may include multi-spectral imagining. By expanding the range of detectable defects by including multi-spectral imaging capabilities, The embodiment FAU inspection systems 100 may allow the system to inspect using various wavelengths of light beyond the visible and IR spectrums. In other embodiments, the FAU inspection system 100 may include 3-D scanning and modelling. By adding 3D scanning technology to create detailed topographic models of the FAU 30 surfaces, embodiment FAU inspection systems 100 may provide additional data points for quality assessment of the FAUs 30 under inspection. In other embodiments, the FAU inspection system 100 may include remote monitoring capabilities. Some embodiment FAU inspection systems 100 may develop a remote monitoring and control interface for the FAU inspection system 100 that enables off-site experts to oversee the inspection process and access inspection data.

In other embodiments, the FAU inspection system 100 may include predictive maintenance algorithms that forecast tool malfunctions and schedule preventative maintenance to minimize downtime of the inspection line. In other embodiments, the FAU inspection system 100 may include user-interface (UI) enhancements that are designed to provide an intuitive UI that provides real-time feedback, visualizations of inspection data, and user-friendly controls for operators with varying levels of expertise. In other embodiments, the FAU inspection system 100 may include customizable inspection modules that offer a modular design that allows for different inspection components to be added or removed depending on the specific inspection needs or FAU 30 designs. In other embodiments, the FAU inspection system 100 may include enhanced alignment systems that incorporate a more sophisticated active alignment systems with higher precision and faster alignment times. Some embodiment FAU inspection systems 100 may include on-the-fly calibration for inspection tools to ensure continuous accuracy without manual intervention. Some embodiment FAU inspection systems 100 may include robotic manipulators that add precision robotic arms to handle and manipulate FAUs, reducing the risk of human error and improving throughput. Still other embodiment FAU inspection systems 100 may include safety and contamination controls that prevent contamination of the FAU 30 during inspection, such as a clean-room-compatible design or integration with existing clean room environments. Other embodiment FAU inspection systems 100 may include interoperability with manufacturing execution systems (MES) that ensure the embodiment FAU inspection system 100 can interface with MES and other quality management systems for seamless data flow and process control within manufacturing environments. By incorporating these additional features, the embodiment FAU inspection systems 100 may offer enhanced performance, greater versatility, and improved integration within the FAU manufacturing and quality assurance processes.

Referring collectively to all drawings and according to various embodiments of the present disclosure, a FAU inspection system 100, for assessing Fiber Array Units 30 in co-packaged optics applications is provided. The FAU inspection system 100 includes a high-resolution charge-coupled device (CCD) imaging system that includes a side CCD unit 14, a top CCD unit 16, and a back CCD unit 18; an infrared (IR) CCD 7 that may assess the core pitch position of an FAU 30; a beam profiler 4 for evaluating beam quality of the optical fibers 46 of at least one FAU 30; a laser source 32; a beam splitter 34 that connects the laser source 32 to the FAU 30; a power detector 9 for measuring the insertion loss of the FAU 30; an active alignment system with left and right 6-axis alignment units 24 and 26 for aligning the at least one FAU 30; and a bottom X-Y plane stage unit 12, configured to hold and adjust the orientation of the CCD imaging system, IR CCD 7, beam profiler 4, power detector 9, alignment units 24 and 26, and the FAU 30, and operates in various inspection modes.

In one embodiment, the first inspection mode (mode-1) of the FAU inspection system 100, a visible camera 2, part of the CCD imaging system, is utilized to capture images of the FAU 30 for automatic defect detection, linear alignment measurement, and confirming pitch or separation distances between the optical fibers of the FAU 30. In one embodiment, the second inspection mode (mode-2) of the FAU inspection system 100, uses the IR camera 6 in conjunction with the bottom X-Y plane stage unit 12 to perform a three-dimensional scan of the FAU 30 using IR wavelengths to assess the core pitch position. In one embodiment, the third inspection mode (mode-3) of the FAU inspection system 100, uses the IR CCD in conjunction with the bottom X-Y plane stage unit 12 to perform a three-dimensional scan of the FAU, using IR wavelengths to assess core pitch position. In one embodiment, the second inspection mode (mode-2) of the FAU inspection system 100, uses the beam profiler 4 to assess the quality and integrity of the optical fibers 46 within the FAU 30 by measuring the output beams from each optical fiber 46. In one embodiment, in a fourth inspection mode (mode-4), the power detector 9 is used to measure the insertion loss of each optical fiber 46 in the FAU 30 by analyzing the attenuation of light passing through the optical fibers 46. In one embodiment, the IR CCD 7 and bottom X-Y plane stage unit 12 are configured to adjust a position and angle of the FAU 30 for IR imaging and core pitch assessment. In one embodiment, the left and right 6-axis alignment units 24, 26 produce movement in six axes: X, Y, Z, pitch, roll, and yaw. In one embodiment, the FAU inspection system 100 further includes a power meter 8 for measuring optical power levels in the FAU 30. In one embodiment, the FAU inspection system 100 uses the laser source 32 and photodetector 44 to measure light attenuation and calculate insertion loss in decibels. In one embodiment, the FAU 30 has a first surface, a second surface that opposes the first surface, and a third surface that connects the first and second surfaces together; the beam splitter 34 is connected to the first surface; a holder mounts the third surface of the FAU 30 to the alignment units 24, 26; and wherein the second surface of the FAU 30 faces the side CCD unit 14 in a first inspection mode (mode-1), the second surface of the FAU 30 faces the IR camera 6 in a second inspection mode (mode-2), the second surface of the FAU 30 faces the beam profiler 4 in a third inspection mode (mode-3), and the second surface of the FAU 30 faces the power detector 9 in a fourth inspection mode (mode-4). In one embodiment, the alignment units 24, 26, holder 60, and FAU 30 are spaced away from the bottom X-Y plane stage unit 12 in a direction that is perpendicular to a longitudinal direction of the bottom X-Y plane stage unit 12. In one embodiment, a golden FAU 62 (i.e. test FAU), configured for the FAU 30 to be compared to the golden FAU 62 in a fifth inspection mode (mode-5), has a first surface, a second surface that opposes the first surface, and a third surface that connects the first and second surfaces together; a holder 60 that has a first surface and a second surface that opposes the first surface, wherein the holder 60 mounts the third surface of the golden FAU 62 to alignment units 24, 26 because the first surface of the holder 60 abuts the golden FAU 62 and the second surface of the holder 60 abuts the alignment units 24, 26; the alignment units 24, 26, holder 60, and golden FAU 62 are stacked on the bottom X-Y plane stage unit 12; the holder 60 extends past the alignment unit 24, 26 in a direction perpendicular to a longitudinal direction of the bottom X-Y plane stage unit 12, such that the second surface of the holder 60 directly faces the bottom X-Y plane stage unit 12. In one embodiment, the IR camera 6 is integrated with the IR CCD 7 and the IR camera 6 has a tilt angle of 5 degrees. In one embodiment, the laser source 32 emits a laser at 0.366 mW to the photodetector 44, and the power loss is between 0.10-0.12 dB. In one embodiment, the laser source 32 emits a laser at 0.366 mW to the beam profiler.

According to another aspect of the present disclosure, a method for inspecting Fiber Array Units (FAUs) 30 in co-packaged optics applications using an integrated inspection system tool 100 is provided, wherein the method comprises: performing a first inspection mode (mode-1) using a visible camera 2 to capture images of the FAU 30, wherein the images are analyzed to detect defects, measure linear alignment of the optical fibers 46, and confirm pitch or separation distances between optical fibers 46; executing a second inspection mode (mode-2) using an Infrared (IR) camera 6 to perform a three-dimensional scan of the FAU 30, wherein the IR camera 6 assesses core pitch position by capturing images at various angles; conducting a third inspection mode (mode-3) using a Beam Profiler 4 to assess beam quality by measuring the shape and intensity of output beams from each fiber within the FAU 30; implementing a fourth inspection mode (mode-4) to measure insertion loss by analyzing the attenuation of light passing through each optical fiber 46 in the FAU 30; undertaking a fifth inspection mode (mode-5) wherein the light outputs of the FAU 30 are compared against a golden FAU 62, measuring misalignments or differences in output beams from design or optimal locations, to evaluate the overall quality and performance of the FAU 30 compared to the golden FAU 62.

In one embodiment, in modes 1-4, the FAU 30, a holder 60, and alignment units 24, 26 are configured to move along a longitudinal direction of the bottom X-Y plane stage unit 12. In one embodiment, in mode-5 an incident beam angle of 14.1 degrees is used for entry of the laser beam into both the FAU 30 and golden FAU 62. In one embodiment, in mode-5 the measuring of misalignments is between four circular channels of both the FAU 30 and the golden FAU 62. In the fourth inspection mode (mode-4), the FAU inspection system 100 utilizes the power detector 9. This component measures the insertion loss of each optical fiber 46 in the FAU 30 by analyzing the attenuation of light as it passes through the fibers.

According to another aspect of the present disclosure, a method of inspecting a Fiber Array Unit 30 in a co-packaged optics application using this apparatus is provided; wherein the method includes positioning the FAU 30 within the apparatus; utilizing a high-resolution CCD imaging system to capture detailed images of the FAU 30; using an IR CCD 7 to assess the core pitch position of the FAU 30; and measuring the quality of output beams from the FAU's 30 optical fibers using a beam profiler 4; and actively aligning the FAU 30 using the left and right 6-axis alignment units 24, 26.

The various embodiments of the present disclosure provide for a FAU inspection system 100 for FAUs 30 that provides a significant improvement over existing technologies by incorporating a comprehensive set of features designed for the modern co-packaged optics industry. The embodiment FAU inspection systems 100 offer advanced capabilities while maintaining operational simplicity and efficiency.

The foregoing outlines features of several embodiments so that those skilled in the art may better understand the aspects of the present disclosure. Each embodiment described using the term “comprises” also inherently discloses additional embodiments in which the term “comprises” is replaced with “consists essentially of” or with the term “consists of,” unless expressly disclosed otherwise herein. Whenever two or more elements are listed as alternatives in a same paragraph of in different paragraphs, a Markush group including a listing of the two or more elements is also impliedly disclosed. Whenever the auxiliary verb “may” is used in this disclosure to describe formation of an element or performance of a processing step, an embodiment in which such an element or such a processing step is not performed is also expressly contemplated, provided that the resulting apparatus or device may provide an equivalent result. As such, the auxiliary verb “may” as applied to formation of an element or performance of a processing step should also be interpreted as “may” or as “may, or may not” whenever omission of formation of such an element or such a processing step is capable of providing the same result or equivalent results, the equivalent results including somewhat superior results and somewhat inferior results. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An inspection tool for monitoring a quality of Fiber Array Units (FAUs) in co-packaged optics applications, comprising:
a high-resolution charge-coupled device (CCD) imaging system that includes a side CCD unit, a top CCD unit, and a back CCD unit;
an infrared (IR) CCD for assessing core pitch position of at least one FAU;
a beam profiler for evaluating beam quality of optical fibers of the at least one FAU;
a laser source;
a beam splitter that connects the laser source to the at least one FAU;
a power detector for measuring insertion loss of the at least one FAU;
an active alignment system with left and right 6-axis alignment units for aligning the at least one FAU; and
a bottom X-Y plane stage unit configured for holding and adjusting an orientation of the CCD imagine system, IR CCD, beam profiler, power detector, alignment units, and the at least one FAU, wherein the inspection tool is configured to operate in a plurality of inspection modes.

2. The inspection tool of claim 1, wherein in a first inspection mode (mode-1), the tool utilizes a visible camera, integrated with the CCD imaging system, to capture images of the at least one FAU for automatic defect detection, linear alignment measurement, and pitch or separation distance confirmation between optical fibers of the at least one FAU.

3. The inspection tool of claim 1, wherein in a second inspection mode (mode-2), the inspection tool uses the IR CCD in conjunction with the bottom X-Y plane stage unit to perform a three-dimensional scan of the at least one FAU, using IR wavelengths to assess core pitch position.

4. The inspection tool of claim 1, wherein in a third inspection mode (mode-3), the beam profiler is utilized to assess the quality and integrity of optical fibers within the at least one FAU by measuring output beams from each optical fiber.

5. The inspection tool of claim 1, wherein in a fourth inspection mode (mode-4), the inspection tool uses the power detector to measure the insertion loss of each optical fiber in the at least one FAU by analyzing an attenuation of light passing through each of the optical fibers.

6. The inspection tool of claim 3, wherein the IR CCD and bottom X-Y plane stage unit are configured to adjust a position and an angle of the at least one FAU for IR imaging and core pitch assessment.

7. The inspection tool of claim 1, wherein the left and right 6-axis alignment units produce movement in six axes: X, Y, Z, pitch, roll, and yaw.

8. The inspection tool of claim 1, further comprising: a power meter for measuring optical power levels in the at least one FAU.

9. The inspection tool of claim 5, wherein the inspection tool uses the laser source and photodetector to measure light attenuation and calculate insertion loss in decibels.

10. The inspection tool of claim 1, wherein the at least one FAU has a first surface, a second surface that opposes the first surface, and a third surface that connects the first and second surfaces together;
the beam splitter is connected to the first surface;
a holder mounts the third surface of the at least one FAU to the alignment units; and
wherein the second surface of the at least one FAU faces the side CCD unit in a first inspection mode (mode-1), the second surface of the at least one FAU faces the IR CCD in a second inspection mode (mode-2), the second surface of the at least one FAU faces the beam profiler in a third inspection mode (mode-3), and the second surface of the at least one FAU faces the power detector in a fourth inspection mode (mode-4).

11. The inspection tool of claim 10, wherein the alignment units, holder, and the at least one FAU are spaced away from the bottom X-Y plane stage unit in a direction that is perpendicular to a longitudinal direction of the bottom X-Y plane stage unit.

12. The inspection tool of claim 1, wherein a golden FAU, configured to be compared against the at least one FAU in a fifth inspection mode (mode-5), has a first surface, a second surface that opposes the first surface, and a third surface that connects the first surface and the second surface together;
a holder that has a first surface and a second surface that opposes the first surface, wherein the holder mounts the third surface of the golden FAU to alignment units because the first surface of the holder abuts the golden FAU and the second surface of the holder abuts the alignment units;
wherein the alignment units, holder, and the golden FAU are stacked on the bottom X-Y plane stage unit; and
wherein the holder extends past the alignment unit in a direction perpendicular to a longitudinal direction of the bottom X-Y plane stage unit, such that the second surface of the holder directly faces the bottom X-Y plane stage unit.

13. The inspection tool of claim 1, wherein an IR camera is integrated with the IR CCD and the IR camera has a tilt angle of 5 degrees.

14. The inspection tool of claim 1, wherein the laser source emits a laser at 0.366 mW to a photodetector, and a power loss is between 0.10-0.12 dB.

15. The inspection tool of claim 1, wherein the laser source emits a laser at 0.366 mW to the beam profiler.

16. A method for inspecting Fiber Array Units (FAUs) in co-packaged optics applications using an integrated inspection system tool, the method comprising:
performing a first inspection mode (mode-1) using a visible camera to capture images of a FAU, wherein the images of the FAU are analyzed to detect defects, measure linear alignment of optical fibers of the FAU, and confirm pitch or separation distances between the optical fibers of the FAU;
executing a second inspection mode (mode-2) using an Infrared (IR) camera to perform a three-dimensional scan of the FAU, wherein the IR camera assesses core pitch position by capturing images of the FAU at various angles;
conducting a third inspection mode (mode-3) using a Beam Profiler to assess beam quality by measuring a shape and an intensity of output beams from each of the optical fibers of the FAU;
implementing a fourth inspection mode (mode-4) to measure insertion loss by analyzing an attenuation of light passing through each of the optical fibers in the FAU; and
undertaking a fifth inspection mode (mode-5) wherein the light outputs of the FAU are compared against light outputs of a test FAU, measuring misalignments or differences in output beams from design or optimal locations, to evaluate the overall quality and performance of the FAU compared to the test FAU.

17. The method of claim 16, wherein in modes 1-4, the FAU, a holder, and alignment units are configured to move along a longitudinal direction of a bottom X-Y plane stage unit.

18. The method of claim 16, wherein in mode-5 an incident beam angle of 14.1 degrees is used for entry of a laser beam into both the FAU and test FAU.

19. The method of claim 16, wherein in mode-5 the measuring of misalignments or differences is between four circular channels of both the FAU and the test FAU.

20. A method of inspecting a Fiber Array Unit (FAU) in a co-packaged optics application using an inspection apparatus, comprising:
positioning the FAU in the inspection apparatus;
utilizing a high-resolution CCD imaging system to capture detailed images of the FAU;
using an IR CCD to assess a core pitch position of the FAU;
measuring the quality of output beams from optical fibers of the FAU using a beam profiler; and
actively aligning the FAU using left and right 6-axis alignment units.
